(19) United States
(12) Patent Application Publication
(10) Pub. No.: US 2007/0157193 A1
(43) Pub. Date: Jul. 5, 2007

(54) Image forming device upgrade via optical scanning of a media sheet

(75) Inventors: Tommy Otis Lowe, Lexington, KY (US); Ricky Earl Robbins, Harrodsburg, KY (US); Joseph Kamal Yackzan, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/325,288

(22) Filed: Jan. 4, 2006

(51) Int. Cl. G06F 9/44

(52) U.S. Cl. 717/168

(57) ABSTRACT

An image forming device may be upgraded through scanning an encoded upgrade sheet. A controller and associated circuitry in the image forming device may extract upgrade data, including firmware data for the device, from the scanned upgrade sheet and write the data to a memory device. The upgrade sheets may include an image comprising a pattern of data blocks, with each block having a color shade representative of binary data. The upgrade sheets may be distributed to users in different manners, including mailing upgrade sheets, electronically mailing the image, or providing the image on a network accessible to the users. The upgrade sheets may include a preamble that triggers the upgrade procedure as well as header and footer information describing the upgrade data.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

Image forming devices usually have resident firmware that comprises a software program or set of instructions stored on a hardware device. The firmware may provide information for how the device boots, operates, or communicates with other devices. Firmware is often stored in non-volatile flash memory of a hardware device. The term “non-volatile” implies that the contents in memory are not erased when power is removed from the device. However, flash memory can be erased and rewritten as desired. Thus, firmware can be thought of as “semi-permanent” since it remains the same unless it is updated by a firmware updater.

For instance, firmware in personal computer devices, such as data drives and video cards, may require updating to fix bugs, to work with a new operating system, or simply to make their devices work more efficiently. To that end, device manufacturers often make firmware updates available on a network (e.g., the Internet) for download and execution on the personal computer. In some instances, such as with optical drives, the firmware upgrade data may be burned to an optical disc, such as a CD or DVD. In this case, the optical drive reads the optical disc and upgrades the firmware by flashing the memory device with the upgrade data.

Similarly, the firmware in an image forming device may be upgraded periodically. In some cases, the image forming device is coupled to a host computer or to a host network. In these situations, a firmware upgrade process can be initiated from the host computer or from a computer on the host network with the upgrade data transmitted to the image forming device through an included wired or wireless communications port. Unfortunately, this approach may not be possible for stand-alone image forming devices that are not coupled to a host computer or to a host network. For example, some multifunction devices may be used primarily as a fax/copier machine. In other cases, the image forming device may be coupled to a host computer that does not have Internet or network access. Thus, conventional methods of upgrading firmware in an image forming device do not appear to address situations where the image forming device is used in a stand-alone manner.

### SUMMARY

Embodiments of the present invention are directed to a technique for upgrading image forming devices. The upgrade process may be implemented on an image forming device having a scanner to scan an upgrade sheet. The device may also have a controller and associated circuitry to receive information from the scanner, extract upgrade data from the scanned information, and write the data to a memory device. The data may comprise firmware data that is flashed to non-volatile memory. A variety of device types are contemplated, including those devices having a flatbed scanner, feed-through scanner, and alignment sensors. The device may further include a user interface panel having a display on which a menu tree is provided. There may be a menu option to initiate an upgrade procedure. In other embodiments, the controller and associated circuitry may recognize a trigger pattern in the scanned upgrade sheet that causes the device to begin the upgrade procedure. Alternatively, the controller and associated circuitry may initiate an upgrade process upon detecting a predetermined user input sequence.

Upgrade data may be encoded into a two-dimensional image printable onto a media sheet. The image may include a pattern of data blocks, with each block having a color shade representative of binary data. The spatial resolution of the pattern of data blocks may be adjusted in accordance with a scan resolution of the image forming device. Further, the image may include header and footer information describing the upgrade data that is recognizable by the image forming device.

The upgrade sheets may be sent to users using a variety of distribution schemes. In one embodiment, a hard copy of the upgrade sheet may be mailed to users. Alternative approaches involve electronically mailing the printable upgrade image or providing the upgrade image on a network accessible to the users.

### BRIEF DESCRIPTION OF THE DRAWINGS

FIG. 1 is a perspective view of an exemplary image forming device on which embodiments of the present invention may be implemented;

FIG. 2 is a functional block diagram of an exemplary image forming device on which embodiments of the present invention may be implemented;

FIGS. 3A and 3B are illustrative examples of upgrade sheets that may be scanned to upgrade an image forming device in accordance with the present invention;

FIG. 4 is a diagram of a single-bit per data block encoding scheme according to one embodiment of the present invention;

FIG. 5 is a diagram of a binary word represented using a single-bit per data block encoding scheme according to one embodiment of the present invention;

FIG. 6 is a diagram of a two-bit per data block encoding scheme according to one embodiment of the present invention;

FIG. 7 is a diagram of a binary word represented using a two-bit per data block encoding scheme according to one embodiment of the present invention;

FIG. 8 is a diagram of a multiple-bit per data block encoding scheme according to one embodiment of the present invention;

FIG. 9 is a diagram of an upgrade sheet that may be scanned to upgrade an image forming device in accordance with the present invention;

FIG. 10 is a perspective view of an exemplary image forming device on which embodiments of the present invention may be implemented;

FIG. 11 is a diagram of an upgrade sheet distribution scheme according to one embodiment of the present invention;

FIG. 12 is a diagram of an upgrade sheet distribution scheme according to one embodiment of the present invention; and

FIG. 13 is a diagram of a block pattern encoding scheme according to one embodiment of the present invention.

### DETAILED DESCRIPTION

The present invention is directed to embodiments of devices and methods for upgrading an image forming device. The process may be applied to upgrade firmware in stand-alone devices. In one or more embodiments, firmware data is encoded into blocks of data printed on a media sheet that may be optically scanned by the image forming device. The scanned data may flashed to memory to complete the upgrade.

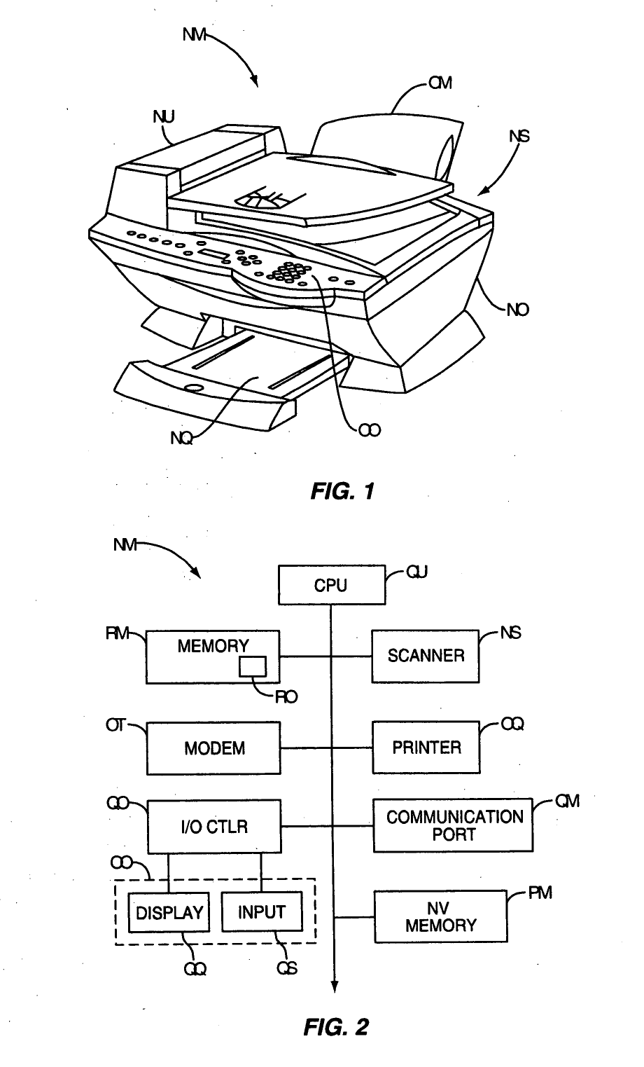

The firmware upgrade techniques disclosed herein may be implemented in a variety of image forming devices. For instance, the firmware upgrade may be executed on a multifunction device such as that generally illustrated in FIG. 1. FIG. 1 depicts one embodiment of a representative multifunction device, such as an All-In-One (AIO) device, indicated generally by the numeral 10. A multifunction device 10 is shown, but other image forming devices, including laser printers and inkjet printers are also contemplated. In the embodiment shown, the multifunction device 10 comprises a main body 12, at least one media tray 20, a flatbed scanner 16 comprising a document handler 18, a media output tray 14, and a user interface panel 22. The multifunction device 10 is adapted to perform multiple home or business office functions such as printing, faxing, scanning, and copying. Consequently, the multifunction device 10 includes further internal components not visible in the exterior view shown in FIG. 1 (but see FIG. 2). The scanner 16 may scan documents, including magazines, books, or other types of media that are placed on the flat bed. Alternatively, single media sheets may be scanned upon feeding through the document handler 18.

With regards to the firmware upgrade techniques disclosed herein, certain embodiments may permit operator control over the process to the extent that a user may initiate the upgrade process. Accordingly, the user interface components, including the user interface panel 22 of the multifunction device 10, may be used to initiate the upgrade. As such, the relationship between the user interface and the processing components is more clearly shown in the functional block diagram provided in FIG. 2.

FIG. 2 provides a simplified representation of some of the various functional components of the exemplary multifunction device 10. For instance, the multifunction device 10 includes the previously mentioned scanner 16 as well as an integrated printer 24, which may itself include a conventionally known ink jet or laser printer with a suitable document transport mechanism. Interaction at the user interface 22 is controlled with the aid of an I/O controller 42. Thus, the I/O controller 42 generates user-readable graphics at a display 44 and interprets commands entered at a keypad 46. The display 44 may be embodied as an alphanumeric LCD display and keypad 46 may be an alphanumeric keypad. Alternatively, the display and input functions may be accomplished with a composite touch screen (not shown) that simultaneously displays relevant information, including images, while accepting user input commands by finger touch or with the use of a stylus pen (not shown).

The exemplary embodiment of the multifunction device 10 also includes a modem 27, which may be a fax modem compliant with commonly used ITU and CCITT compression and communication standards such as the ITU-T series V recommendations and Class 1-4 standards known by those skilled in the art. The multifunction device 10 may also be coupled to a computer or network (not shown) through a compatible communication port 40, which may comprise a standard parallel printer port or a serial data interface such as USB 1.1, USB 2.0, IEEE-1394 (including, but not limited to 1394a and 1394b) and the like. The communications port, 40 is conventionally used for data transfer, including image data for print jobs initiated by host computers or network computers. Where a two-way communication link is established at communications port 40, information such as scanned images or incoming fax images may be transmitted from the multifunction device 10 to a computer or network.

The multifunction device 10 may also include integrated wired or wireless network interfaces. Therefore, communication port 40 may also represent a network interface as opposed to a point to point interface. A wired communication port 40 may comprise a conventionally known RJ-45 connector for connection to a 10/100 LAN or a 1/10 Gigabit Ethernet network. A wireless communication port 40 may comprise an adapter capable of wireless communications with other devices in a peer mode or with a wireless network in an infrastructure mode. Accordingly, the wireless communication port 40 may comprise an adapter conforming to wireless communication standards such as Bluetooth®, 802.11x, 802.15 or other standards known to those skilled in the art.

The multifunction device 10 may also include one or more processing circuits 48, system memory 50, which generically encompasses RAM and/or ROM for system operation and code storage as represented by numeral 52. The system memory 50 may suitably comprise a variety of devices known to those skilled in the art such as SDRAM, DDR SDRAM, EEPROM, Flash Memory, and perhaps a fixed hard drive. Those skilled in the art will appreciate and comprehend the advantages and disadvantages of the various memory types for a given application.

Additionally, the exemplary multifunction device 10 includes non-volatile memory 30 (identified as NV MEMORY), in which the device firmware is stored. As used herein, the term “firmware” is intended to refer generally to data, software programs, or a set of instructions programmed on a programmable device. With regards to the exemplary multifunction device 10, the firmware stored in memory 30 may comprise initialization instructions, color correction tables, device identification data, and other information that is used to define how the device 10 operates or communicates with other devices.

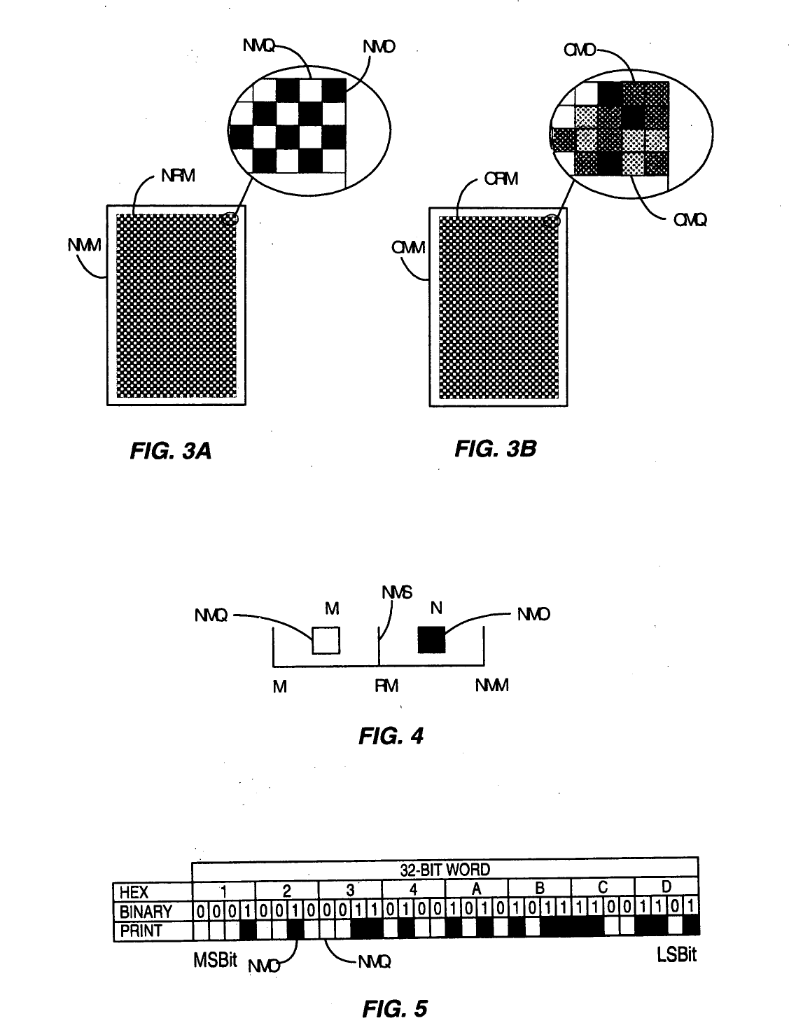

The firmware in the exemplary multifunction device 10 may be updated as needed by scanning an upgrade sheet similar to those 100, 200 shown in FIGS. 3A and 3B. Upgrade sheets 100, 200 comprise encoded firmware upgrade data imprinted thereon in the form of a two-dimensional image of a plurality of data blocks 150, 250. The encoded data forms a binary file of data to replace some or all of the firmware that is stored within memory 30. In FIGS. 3A and 3B, a data block 150, 250 represents a data location, with each block having a plurality of possible color values. For example, in FIG. 3A, the upgrade sheet 100 includes a plurality of black 102 and white 104 data blocks 150. In one embodiment, each data block 150 represents a single bit of data in the binary file. This type of encoding is illustrated in FIG. 4, which shows the exemplary data blocks 102, 104. As indicated, data block 102 is printed in black while data block 104 is printed in white. In the coding example shown, a black data block 102 is identified by the scanning device 10 if the detected color intensity exceeds a threshold 106. Similarly, a white data block 104 is identified if the detected color intensity falls below a threshold 106. In one embodiment, the threshold may be at or near the midpoint of color intensity values used to represent white and black colors. As illustrated, the black data block 102 represents a high bit or “1” while the white data block 104 represents a low bit or “0.” Naturally, this encoding may be reversed such that a white data block 104 represents a 1 while a black data block 102 represents a 0.

Using this type of encoding, strings of data blocks 150 may be grouped together to represent bytes and words of binary data. An example of a printed pattern representing the hexadecimal, 32-bit word 1234ABCD is illustrated in FIG. 5. Each hexadecimal digit may have one of 16 possible values and is accordingly represented by four bits. Using the printed data block encoding scheme shown in FIG. 4, the corresponding printed pattern is shown in FIG. 5 with the most significant bits appearing on the left side of the block string. The least significant bits appear toward the right side of the block string. As suggested above, each data block 102, 104 represents a single bit of data. Accordingly, 32 black and white data blocks 102, 104 are used to represent the 32-bit word.

The same amount of information may be printed in fewer data blocks through the use of grayscale values. Many scanners, including flatbed and feed-through scanners known in the art (e.g., scanner 16 shown in FIG. 1), are able to distinguish color levels. Thus, more information may be encoded in a comparable area through the use of gray levels. In the embodiment shown in FIG. 3B, the upgrade sheet 200 includes a plurality of data blocks 250, each having one of a plurality of different grayscale intensity values. The grayscale intensity values may comprise a range of intensities for a single color or a plurality of colors. Thus, in one embodiment, the grayscale values may represent a plurality intensities of the color ‘gray’ ranging between white at one extreme and black at the other. As an example, with an 8-bit color depth, the data blocks 250 may take on a plurality of intensity values within a range between 0 and 255. An intensity of 0 may represent either a white or a black data block. Conversely, an intensity of 255 may represent a black or a white data block. The data blocks 250 may be printed with intensities at or near these extremes as well as other intensities in between. For instance, FIG. 3B identifies two specific gray values 202, 204.

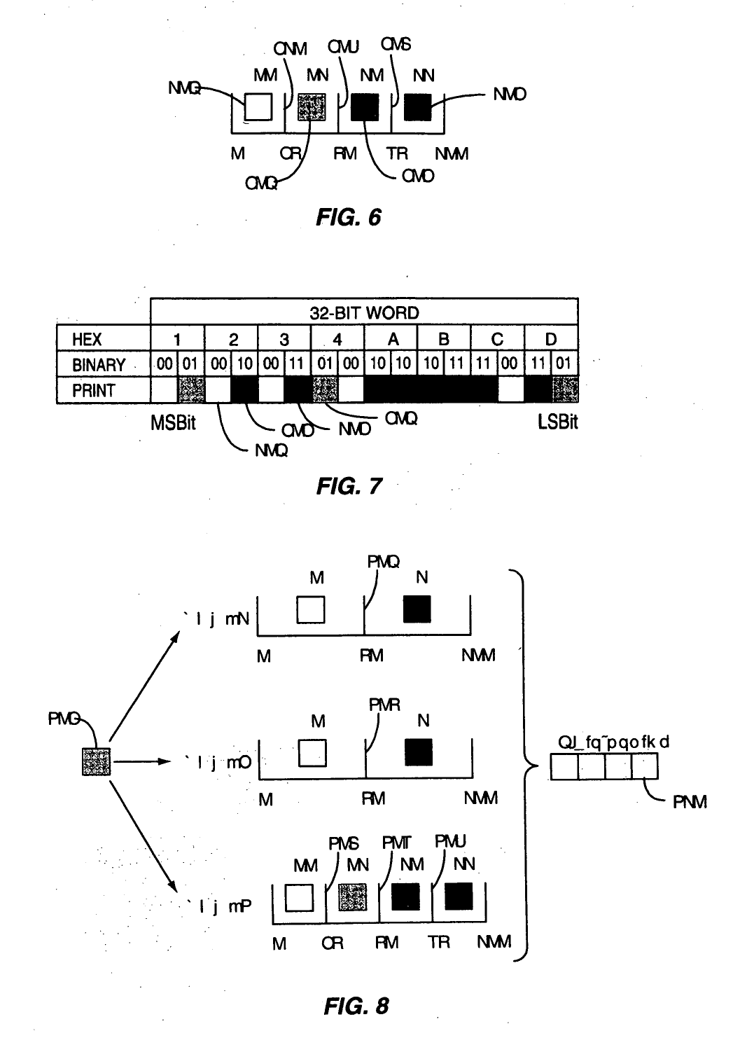

FIG. 6 represents one example of a grayscale encoding scheme. In this example, four different values of the color gray are used to represent four values of a 2-bit character string. For example, block 104 corresponds to the string ‘00,’ block 204 corresponds to ‘01,’block 202 corresponds to ‘10,’ and block 102 corresponds to ‘11.’ It should be understood that these associations are representative and should not be construed as limiting. Black 102 and white 104 data blocks similar to those depicted in FIG. 4 may be used. In addition, other gray data blocks 202, 204 represent intermediate intensity levels. In one embodiment, data blocks 202, 204 are printed at about 33% and 67% of the maximum recognizable intensity value. If one assumes an 8-bit color depth, these intensity values correspond roughly to about 85 and about 170. Detectable color depths will naturally depend on the type of scanner used to read the data.

Thresholds 206, 208, and 210 may be used to distinguish between the different gray levels. In general, it may be desirable to set the threshold at an intensity value that is approximately midway between target printed intensity values for data blocks 102, 104, 202, 204. For instance, in an embodiment where data blocks 202, 204 are printed at 33% and 67% of a maximum intensity, a suitable threshold 208 between these two levels may be at about 50%. Again, using an 8-bit color depth as an example, threshold 208 may be set at about 128.

The upper threshold 206 shown in FIG. 6 may also be set to distinguish between data blocks 102 and 202. In certain embodiments, the threshold 206 may be set between about 75% and 85% of a maximum intensity. Similarly, the lower threshold 210 shown in FIG. 6 may also be set to distinguish between data blocks 104 and 204. In certain embodiments, the threshold 204 may be set between about 15% and 25% of a maximum intensity.

As suggested above, more information may be printed in fewer data blocks 250 through the use of grayscale values. This is exemplified by a comparison between FIGS. 5 and 7, each of which shows a block string representing the same 32-bit word. As described above, the block string shown in FIG. 5 is produced using two colors (e.g., black and white). In contrast, the block string shown in FIG. 7 is produced using the four grayscale levels shown in FIG. 6. Since each color in this example represent two bits, half as many blocks (i.e., 16 versus 32) are needed to represent the same 32-bit word 1234ABCD. Therefore, as more color levels are used, each data block 150, 250 represents more data. Encoding multiple bits per block can be extended further, limited at an upper end by the ability of the scanning device 10 to resolve the different colors. In fact, as indicated above, colors other than “gray” may also be used, allowing three, four, or more bits to be encoded per block. FIG. 8 illustrates one such example.

It is generally understood that a color image scanner resolves color images into multiple (usually three) color components. The scanner may comprise scan elements for each component color or may use filters to determine color intensities at finite image locations, often called dots or pixels. A commonly used color model breaks colors into Red, Green, and Blue components, though other color models are known. For instance, Cyan, Magenta, and Yellow components are sometimes used in color image production. Regardless, as FIG. 8 shows, a given color data block 302 may be detected or otherwise resolved into three color components COMP1, COMP2, and COMP3. Each of these components are monochrome and may represent some portion of an overall bit string 310. In the illustrated example, two of the color components COMP1 and COMP2 are divided into two color levels, each representing 1 bit in a manner similar to the black and white example shown in FIG. 4. The third color component COMP3 is divided into four color levels, each representing 2 bits in a manner similar to the gray examples shown in FIG. 6. The three color components COMP1, COMP2, COMP3 are compared against respective thresholds 304-308. Depending on the intensity values of the components COMP1, COMP2, COMP3 relative to the thresholds 304-308, a 4-bit data string can be decoded. As before, additional color levels can be used to encode more bits per block depending upon the ability of a scanning device 10 to resolve the different colors.

The amount of firmware upgrade data that can be printed onto an upgrade sheet 100, 200 also depends on the size of the data blocks 150, 250. Clearly, as the data blocks 150, 250 get smaller, more data can be encoded onto an upgrade sheet 100, 200. However, at some point, the scan resolution of the scanning device 10 may limit the size of the blocks 150, 250. In a practical application, the resolution of data blocks 150, 250 should be less than or equal to half the scanner 16 resolution. This limitation is derived from known aliasing problems associated with digital sampling and Nyquist frequency limitations. For example, if an upgrade sheet 100, 200 is comprised of data blocks 150, 250 spaced at 300 blocks per inch, a scanner 16 having a resolution of 600 dots or pixels per inch or greater is desirable. Higher resolution scanners 16 may be better able to resolve the block data. It should be noted that the capability of a scanner 16 should be considered on its own merit as some may be more capable than others. As the scanner 16 is better able to resolve the data blocks 150, 250, more data can be printed on an upgrade page.

Table I below illustrates some representative data volumes for 8.5×11 upgrade sheets 100, 200 having data blocks 150, 250 printed at different resolutions and different numbers of bits per block.

TABLE I
DATA VOLUME PER UPGRADE PAGE

| Resolution | 1 Bit/Block | 2 Bits/Block | 4 Bits/Block |
|---|---|---|---|
| 150 Blocks/Inch | 225 KBytes | 450 KBytes | 900 KBytes |
| 300 Blocks/Inch | 900 KBytes | 1.8 MBytes | 3.6 MBytes |
| 600 Blocks/Inch | 3.6 MBytes | 7.2 MBytes | 14.4 MBytes |
| 1200 Blocks/Inch | 14.4 MBytes | 28.8 MBytes | 57.6 MBytes |

In Table I, the data volumes shown assume an 8×10 data region on the 8.5×11 upgrade sheet 100, 200. Further, the resolutions are presumed to be the same in the horizontal and vertical directions. As an example, at 150 Blocks/Inch, a total of 1200 data blocks 150, 250 may be printed in the horizontal direction and a total of 1500 data blocks 150, 250 may be printed in the vertical direction for a total of 1.8 million blocks. This correlates to 1.8 million bits for the 1 bit per block example. Dividing this number by 8 bits per Byte produces the 225 KBytes value shown above. The remaining numbers may be generated in the same manner. Other data volumes based on other page sizes and data block sizes can be generated in the same manner. Notably, the amount of data that can be printed on an upgrade sheet 100, 200 is. fairly substantial, particularly where grayscale and color levels are implemented. Certainly, the representative upgrade sheets 100, 200 can hold enough data to replace most if not all of the resident firmware in the exemplary multifunction device 10.

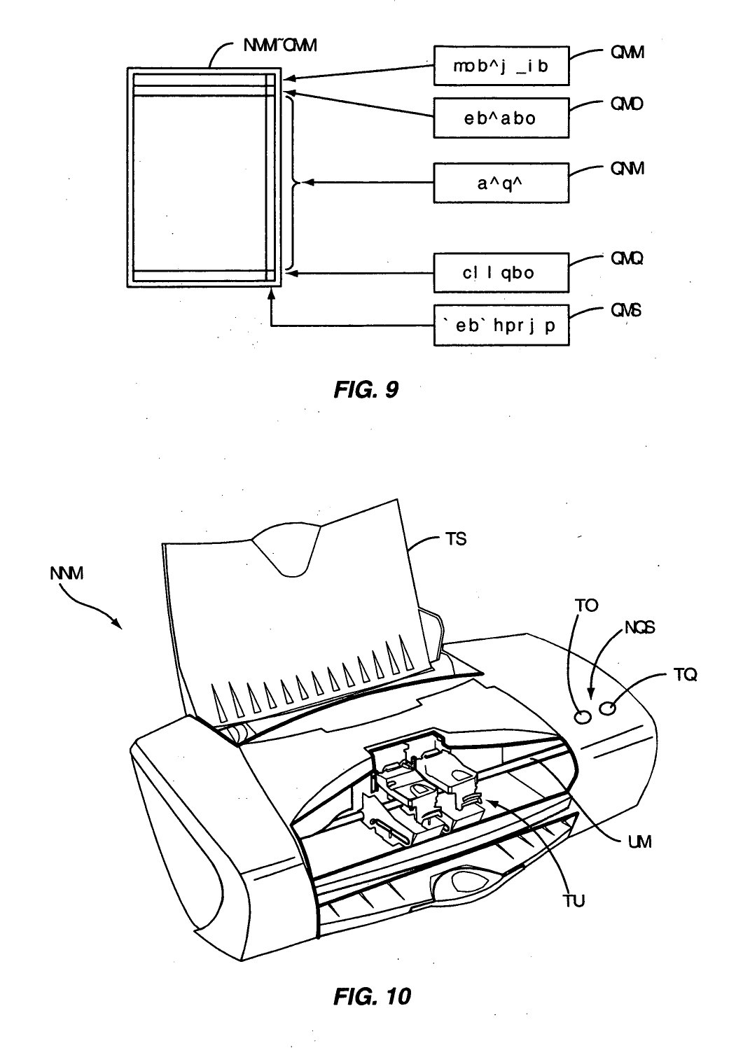

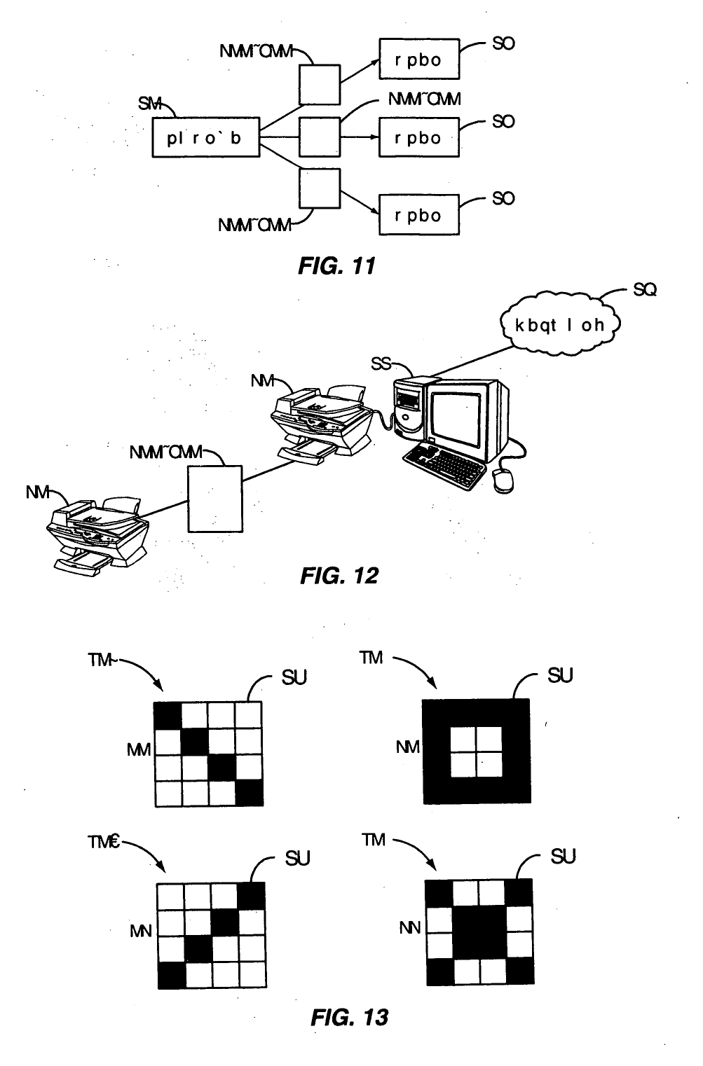

The ability to use most or all of this data volume for the firmware data may be dependent upon the amount of additional data that is encoded on an upgrade sheet 100, 200. For example, additional data may include information that is representative of a disciplined protocol used to define the overall data structure as it is laid out on the upgrade sheet 100, 200. As illustrated in FIG. 9, additional information such as an identifiable preamble 400, header 402, and footer 404 may be used to identify the data 410 as firmware upgrade data. In addition, a checksum 406 may be associated with each row of data. In one embodiment, the checksums 406 are located at the end of each row.

The illustrated example shown in FIG. 9 may be used to automatically initiate an upgrade procedure for the multifunction device 10. In this particular embodiment, a user may simply place the upgrade sheet 100, 200 on the scanner 16 and scan the document in a normal manner. In this case, the preamble 400 triggers the upgrade process. The preamble 400 may contain a predetermined pattern to inform the multifunction device 10 that this is an upgrade page 100, 200. The pattern used as the preamble 400 may be complex to ensure a low likelihood of inadvertent triggering. The header 402 may contain details of the type of upgrade contained in the scan data, such as a full firmware update, a partial update confined to a specific address range in the memory, a table update or other options. The header 402 may also indicate how many lines to scan and how many bytes of data to collect.

As the data is scanned in, the checksums 406 are verified at the end of each line to ensure veracity. Checksums are a known form of redundancy check and provide a measure for protecting the integrity of the scanned data. In a simple variation, the basic components of the data (e.g., bits or bytes) are added and the resulting value is stored at the end of each row. Then as the data is scanned, the detected data is summed and compared to the printed checksum 406. If the sums match, the multifunction device 10 concludes that the message is probably not corrupted. More sophisticated types of redundancy check may be used, including Fletcher's checksum, Adler-32, and cyclic redundancy checks (CRCs). Each of these types may address weaknesses in a simple additive checksum at the expense of increased computation complexity and increased data storage.

The multifunction device 10 should know, based upon information provided in the header 402 when the footer 404 should begin. The footer 404 may contain another encoded message, confirming to the multifunction device 10 that the firmware data 410 ended at the expected location. Once all checksums 406 are verified and all confirmations are complete, the multifunction device 10 may proceed with programming the firmware data 410 into the non-volatile memory 30.

In an alternative embodiment, the data encoded on the upgrade sheet 100, 200 comprises firmware data 410 without the aforementioned preamble 400. In this embodiment, the upgrade process may be initiated by the user through a menu option accessible on the user interface panel 22. Once this menu option is selected, the multifunction device 10 may instruct the user to position the upgrade sheet 100, 200 on the flat bed scanner 16 or feed the upgrade sheet 100, 200 through the document feeder 18. Upon scanning the data and verifying the checksums and data size, the multifunction device 10 may proceed with flashing the firmware data 410 into the non-volatile memory 30.

In an alternative embodiment, the data encoded on the upgrade sheet 100, 200 comprises firmware data 410 without the aforementioned preamble 400, header 402, and footer 404. The data 410 may include the aforementioned checksums 406. In this embodiment, a full firmware upgrade may be presumed and the upgrade process may be initiated by the user through the menu option accessible on the user interface panel 22. Upon scanning the data and verifying the checksums, the multifunction device 10 may proceed by overwriting the entire contents of non-volatile memory 30 with the firmware data 410.

A variation of the previously described start procedures may account for devices that do not have an extensive user interface panel 22 similar to the exemplary image forming device 10. For example, certain devices, such as the image forming device 110 shown in FIG. 10 have a relatively limited user input panel 146 comprising one or more command buttons 72, 74 and a door panel 76 that provides access to internal components. One button 72 may control device 110 power while the other button 74 is a paper feed button. The firmware upgrade procedure may be initiated on a device 110 such as this by entering a particular button 72, 74 sequence or by entering a particular button 72, 74 sequence in combination with opening or closing the door panel 76. Once initiated, the image forming device 110 will feed an upgrade sheet 150, 250 (not shown in FIG. 10) to begin the firmware upgrade.

Notably, the image forming device 110 shown in FIG. 10 is representative of a simple ink jet printer. These types of devices 110 may not have a high resolution color or grayscale scanner of the type (e.g., scanner 16 in FIG. 1) found in multifunction devices 10. However, certain image forming devices 110 may have a reflective type sensor mounted on the print head carrier assembly 78. Generally, these types of sensors are simple reflective sensors adapted to sense light and dark patterns as they move with the print head carrier 78 along the carrier bar 80. In certain device 110, these sensors function as alignment sensors used to appropriately register colors, images, and sheets. Depending on the color sensing capacity of this sensor, the upgrade sheets may be limited to the black and white version of the upgrade sheet 150 illustrated in FIG. 3A. Nonetheless, firmware upgrades may be completed using the teachings described herein on these types of image forming devices 110. This may be stored in memory 50, with the firmware upgrade process described herein executed by some combination of processor 48 and memory 50, 30. Additional logic for carrying out the invention may be stored in programmable logic devices such as PLDs and FPGAs. In general, those skilled in the art will comprehend the various combinations of software, firmware, and hardware that may be used to implement the various embodiments described herein.

The present invention may be carried out in other specific ways than those herein set forth without departing from the scope and essential characteristics of the invention. For example, the embodiments described above have contemplated a direct encoding scheme where colors or patterns have a direct correlation to a predetermined number of bits. However, those skilled in the art of image processing and fax processing will comprehend that various compression algorithms, including lossless run length coding and Huffman coding may be used to increase the data volume of the upgrade sheets 100, 200. The present embodiments are, therefore, to be considered in all respects as illustrative and not restrictive, and all changes coming within the meaning and equivalency range of the appended claims are intended to be embraced therein.

What is claimed is:

1. An image forming device comprising:
a scanner to scan an upgrade sheet; and
a controller and associated circuitry to receive information from the scanner, and extract upgrade data from the information, and write the upgrade data to a memory device.

2. The device of claim 1 wherein the scanner is a flatbed scanner.

3. The device of claim 1 wherein the scanner is an alignment sensor.

4. The device of claim 1 wherein the upgrade data is firmware data.

5. The device of claim 1 wherein the memory device comprises non-volatile memory.

6. The device of claim 1 further comprising a user interface panel having a display, including a menu option to initiate an upgrade procedure.

7. The device of claim 1 wherein the controller and associated circuitry recognizes a trigger pattern in the scanned upgrade sheet.

8. The device of claim 1 wherein the controller and associated circuitry recognizes information extracted from the upgrade sheet describing the upgrade data.

9. The device of claim 1 wherein the controller and associated circuitry initiates an upgrade process upon detecting a predetermined user input sequence.

10. A method of upgrading an image forming device, the method comprising:
encoding upgrade data for the image forming device into a two-dimensional image printable onto a media sheet, the image comprising a pattern of data blocks, each block having a color shade representative of binary data; and
distributing the image pattern to users of the image forming device.

11. The method of claim 10 wherein distributing the image pattern to users of the image forming device comprises mailing an upgrade sheet having the image imprinted thereon.

12. The method of claim 10 wherein distributing the image pattern to users of the image forming device comprises electronically mailing the image.

13. The method of claim 10 wherein distributing the image pattern to users of the image forming device comprises providing the image on a network accessible to the users.

14. The method of claim 10 wherein encoding upgrade data for the image forming device comprises adjusting a spatial resolution of the pattern of data blocks in accordance with a scan resolution of the image forming device.

15. The method of claim 10 wherein encoding upgrade data for the image forming device further comprises encoding a preamble into the image that is recognizable by the image forming device to trigger an upgrade procedure.

16. The method of claim 10 wherein encoding upgrade data for the image forming device further comprises encoding header and footer information into the image describing the upgrade data that is recognizable by the image forming device.

17. A method of upgrading an image forming device, the method comprising:
optically scanning a media sheet to generate image data;
extracting upgrade data from the image data; and
writing the upgrade data into a memory device in the image forming device.

18. The method of claim 17 further comprising entering into an upgrade process upon detecting a predetermined pattern in the image data.

19. The method of claim 17 further comprising verifying the validity of the upgrade data prior to writing the upgrade data into the memory device.

20. The method of claim 17 further comprising entering into an upgrade process upon detecting a predetermined input from a user interface.
